(19) United States
(12) Patent Application Publication
(10) Pub. No.: US 2015/0114208 A1
(43) Pub. Date: Apr. 30, 2015

(54) Method for adjusting the parameters of a musical composition

(71) Applicant: Sergey Alexandrovich LAPKOVSKY, (US)

(72) Inventor: Sergey Alexandrovich Lapkovsky, Lutsk (UA)

(21) Appl. No.: 14/394,315

(22) PCT Filed: Jan. 21, 2013
(86) PCT No.: PCT/UA2013/000008

§ 371 Date: Oct. 14, 2014

(30) Foreign Application Priority Data
Jun. 18, 2012 (UA) 2012 07356

(51) Int. Cl. G10H 1/40

(52) U.S. Cl. CPC G10H 1/40
USPC 84/612

(57) ABSTRACT

The aim of the invention is to harmoniously coordinate the tempo and the key (tonality) of a musical work such that the pulse frequency of the downbeats corresponds to the frequency of the fundamental tone. This defines the sound of a musical composition in terms of harmony, which increases the aesthetic attractiveness for the listener, and owing to the resultant resonance, such a musical composition sounds louder, which improves the power consumption, and increases the ergonomics of the performer. A method for adjusting the parameters of a musical composition is proposed, wherein a technical operator is additionally used which inputs data regarding a musical parameter, namely key (tonality) or tempo, into the system, whereupon corresponding data regarding another musical parameter, namely tempo or key, are determined, and output to the technical operator.

The claimed method for adjusting the parameters of a musical composition relates to means for controlling the parameters of musical compositions during the production of said musical compositions and can be used in processes for producing musical compositions and in processes for processing, adaptation and arranging said musical compositions.

One of the most important principles of musical expressiveness is organization of sounds in time. In any musical composition it is possible to observe a certain regularity of movement. It is connected with the fact that sounds forming the melody are not equivalent in value. Some of them are emphasized by means of power and temporary allocation, therefore, they make an impression of strong sounds while the others do not have such feature. Power or temporary allocation of a certain sound is called an accent. Temporary accents and recessions in music (strong and weak beats) create a certain proportional pulsation. The part of a musical composition from one temporary accent to the next one of equal force, is called a measure (bar). A measure could consist of one or several sounds of identical or different duration. The first beat of the measure is usually the strongest accent and is called strong beat, the others are not accented weak beats. Interchange of strong and weak beats in music are called meter. The fundamental unit of musical meter is the measure. Measure signature (meter) depends on the number of measuring beats in each measure (bar). A measuring beat designated duration of the note: whole note, half note, quarter note, eighth note, sixteenth note.

Each musical composition has its fundamental tonality. Tonality of a musical composition is determined by an absolute pitch of its fundamental tone and inclination of fundamental chord (Maj/min). Pitch of musical tone measured by frequency of oscillations per second and has its place in a musical sound pitch system. A musical system of sound pitch is divided into sections of octaves. In every section names of sounds corresponding to value of sounds in other sections recur (octave compliance). An octave in music and acoustics is the interval between one musical pitch and another with half or double its frequency.

Significant parameter of sound matter of a musical composition is the speed its deployment which is characterized by tempo. Tempo is perceived as pulsation accents speed. It is known that till the 19th century the tempo of musical composition was indicated by means of verbal framework: “quickly”, “slowly” and so forth. Since the 19th century the tempo of musical composition is specified precisely, using metronomic indications. They are shown at the beginning of musical composition or its part, and indicate the frequency of beats designated duration per minute. Pitch of sounds in composition is coordinated in tonality, duration of sounds is coordinated in rhythm and tempo, however available methods and other adjusting means do not provide tempo and tonality coordination in musical composition.

The closest analogue of the claimed decision is the method for adjusting the parameters of a musical composition, including use of a computing device that is capable of choosing compositions according to previously set attributes, for example tempo, or adjusting musical composition to the designated tempo, and also dynamically adjusting the tempo of the selected item to best match the desired tempo (U.S. Pat. No. 7,973,231, IPC G10H 1/00 (2006.01), issued to Apple corporation). The shortcoming of the specified method is the fact that the musical composition is being adjusted to any chosen tempo ignoring harmonious factor, as oscillation frequency of the fundamental tone of composition and frequency of downbeats and measuring beats do not have appropriate harmonious coordination.

The aim of the invention is to provide a method for adjusting the parameters of a musical composition which would make it possible to harmoniously coordinate the tempo and the tonality of a musical composition such that the pulse frequency of the downbeats or measuring beats corresponds to the frequency of the fundamental tone. This makes it possible to refine the sound of a musical composition in terms of harmony, which increases the aesthetic attractiveness of said musical composition for the listener, and owing to the resultant resonance, such a musical composition will sound louder, which will result in savings in respect of the power supply to the apparatus, and increases the ergonomics of the performer.

In order to solve the stated problem, a method for adjusting the parameters of a musical composition is proposed, comprising: including a usage of a system for adjusting the parameters of a musical composition, wherein, a technical operator brings data of the musical parameter into the system: a tonality or a tempo, then a relevant data of another musical parameter is defined: the tempo or the tonality, wherein the parameters are displayed to the technical operator. The technical operator is a producer or a computer device with proper software is used as the technical operator.

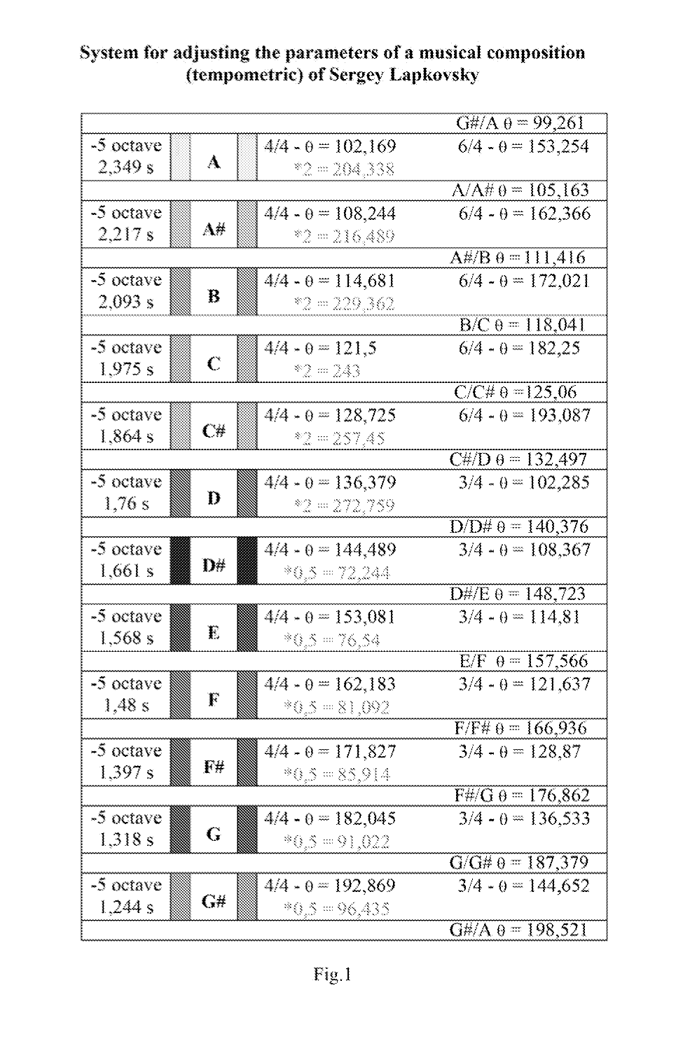

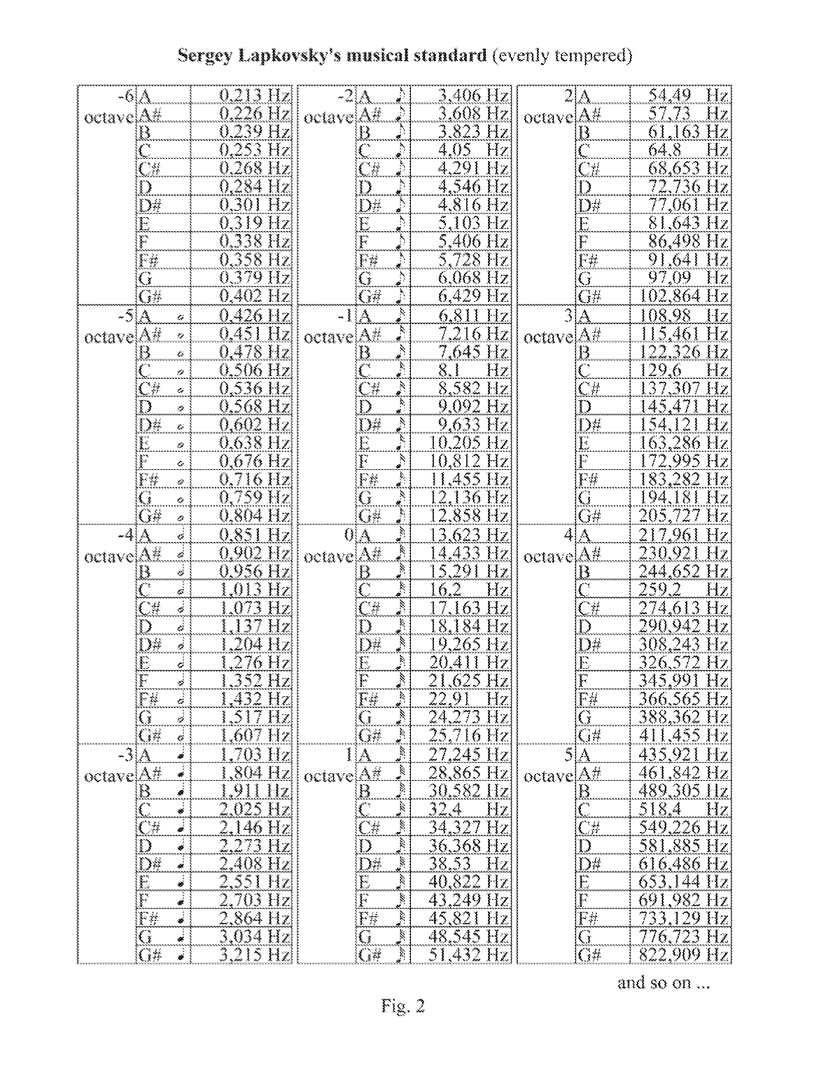

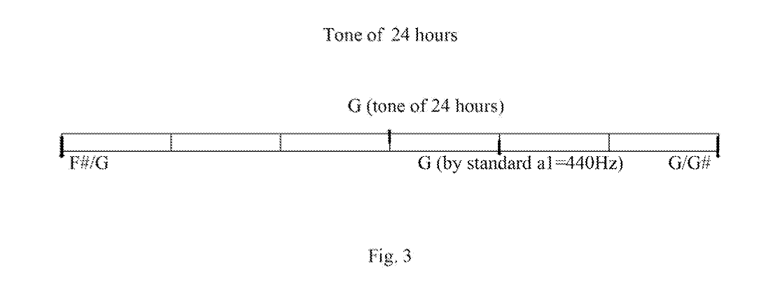

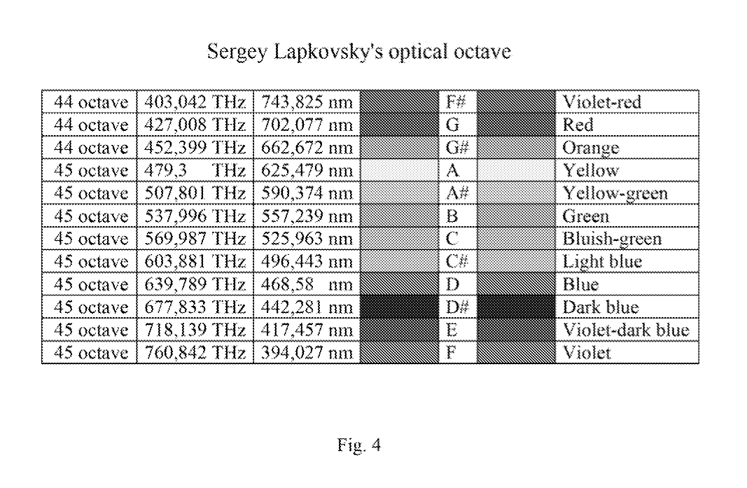

For realization of the claimed method and processing of necessary data, is worth using a system for adjusting the parameters of a musical composition (FIG. 1) in which musical parameters are interconnected: tonality, meter and tempo. In other cases, it is pertinently to update data of this system indicator. This is done as follows: a musical standard is being chosen (for example, it can be Sergey Lapkovsky's musical standard—(FIG. 2), or the international standard of 1939 [symbol] a1=440 Hz [symbol] (A4 according to scientific designation), or any other pitch which can be used). By means of coefficient which uniformly tempers an octave for 12 tones that equals 1,059463094359295264561825294946 and octave ratio (1 to 2) −3,−4 octaves are being built. Take frequencies of tones −3 and −4 octaves in Hz and is multiplied by 60 seconds, that giving frequencies of beats metronome per minute. For convenience, tempo is selected in the range from 100 to 200. Octave of tempo corresponding to 12 tonalities from A to G # is got. As an example, Sergey Lapkovsky's tempometric system (FIG. 1) according to Sergey Lapkovsky's musical standard (FIG. 2) based on frequency of rotation of the Earth around its own axis with respect to the sun, is constructed. It is G tone which is 16,124 cents lower from G tone according to the international standard of 1939−a1=440 Hz (FIG. 3). Sergey Lapkovsky's (tempometric) octave begins with “A” tone and is located for minor third below the traditional. Tempo of the just fifth degree is calculated by multiplying tempo of the first degree by 1,5 (in music and acoustics, the frequency of the first degree are ratio to the frequency of the rising just fifth degree as 1 to 1.5), and since D tonality dividing the result by 2 (octave ratio). Multiplying and dividing the tempo by 2, one can receive alternative twice as quick and twice as slow tempos. Duration of a measure is calculated by dividing one second by frequency of downbeats measure. Borders between tones are calculated by means of the coefficient, which evenly tempers octave for 24 tones that makes 1,029302236643492028782371800774. Such borders between tones make it possible to define tonality of any tempo. To improve memorizing it is possible to label each tonality of the system with certain color, an example is Sergey Lapkovsky's optical octave (FIG. 4). The specified data can be processed and represented as a computer system for user's convenience.

According to the task, considering harmonization of tempo and tonality, meters are divided into three types: octave, perfect fifth and synthetic. Meters in the numerator of which are 1, 2, 4, 8, 16, that is octave compliance, are meter of octave, for example: 1/4, 2/4, 4/4. Meters in the numerator of which are 3, 6, 12, that is perfect fifth compliance, are meter of perfect fifth, for example: 3/4, 6/4. Meters in the numerator of which are 5, 7, 9, 10, 11, 13, 14, 15, are synthetic, for example: 5/4, 7/4. The most perfect is meter of octave. For octave meter the best is the first degree tempo according to tempometric system. Thus in the octave measure, the frequency of downbeats and measuring beats will correspond the fundamental tone. For perfect fifth meter the best is the just fifth degree tempo according to tempometric system. Thus in the measure of perfect fifth, the frequency of downbeats will correspond the fundamental tone, the frequency of measuring beats will correspond the fifth degree. For perfect fifth meter it is possible to use the first degree tempo, in that case the frequency of downbeats will correspond the fourth degree, the frequency of measuring beats will correspond the fundamental tone. For synthetic meter the best is the first degree tempo, thus the frequency of measuring beats will correspond the fundamental tone.

As a result of the implementation of this method, the quality and aesthetic attractiveness of a musical composition are increased.

What is claimed is:

1. A method for adjusting parameters of a musical composition, comprising: including a usage of a system for adjusting the parameters of a musical composition, wherein, a technical operator brings data of the musical parameter into the system: a tonality or a tempo, then a relevant data of another musical parameter is defined: the tempo or the tonality, wherein the parameters are displayed to the technical operator.

2. The method according to claim 1, wherein the technical operator is a producer or a computer device with proper software is used as the technical operator.
